(19) United States
(12) Patent Application Publication
(10) Pub. No.: US 2010/0042731 A1
(43) Pub. Date: Feb. 18, 2010

(54) METHODS, SYSTEMS, AND COMPUTER READABLE MEDIA FOR SESSION INITIATION PROTOCOL (SIP) DIALOG IDENTIFICATION

(76) Inventor: Robert J. Sparks, Plano, TX (US)

Correspondence Address: JENKINS, WILSON, TAYLOR & HUNT, P. A., Suite 1200 UNIVERSITY TOWER, 3100 TOWER BLVD.,, DURHAM, NC, 27707, US

(21) Appl. No.: 12/534,762

(22) Filed: Aug. 3, 2009

Related U.S. Application Data
(60) Provisional application No. 61/085,677, filed on Aug. 1, 2008.

(51) Int. Cl. G06F 15/16

(52) U.S. Cl. 709/228

(57) ABSTRACT

Methods, systems, and computer readable media for session initiation protocol (SIP) dialog identification are disclosed. According to one method, a first SIP message associated with a SIP dialog is received. A dialog ID that is associated with the SIP dialog is computed using fields of the first SIP message. A second SIP message associated with the SIP dialog is generated. The computed dialog ID is included in the second message.

### RELATED APPLICATIONS

This application claims the benefit of U.S. Provisional Patent Application Ser. No. 61/085,677 filed Aug. 1, 2008, the disclosure of which is incorporated herein by reference in its entirety.

### TECHNICAL FIELD

The subject matter described herein relates to session initiation protocol (SIP). More specifically, the subject matter relates to methods, systems, and computer readable media for SIP dialog identification.

### BACKGROUND

Session initiation protocol (SIP), specified in the Internet Engineering Task Force (IETF) RFC 3261, is used for call and session control of multimedia communication sessions between parties exchanging various forms of media, such as voice and video. A SIP network may include various SIP network elements for establishing and tearing down: communications sessions. One such element includes a SIP user agent (UA). As used herein, a “SIP UA” or “UA” refers to a logical network endpoint used to communicate SIP messages. A UA may perform the role of a user agent client (UAC), which sends SIP requests, or a user agent server (UAS), which receives requests and returns SIP responses. Other SIP elements, such as a SIP proxy, may also be involved. As used herein, a “SIP proxy” refers to an intermediary device in a SIP network that acts as both a server and a client for the purpose of making requests on behalf of other clients and primarily plays the role of routing messages to one or more associated devices.

An important concept in SIP is the use of transactions, dialogs, and calls. As used herein, a “SIP transaction” includes a request along with all associated responses up to a final (non-1xx) response. As used herein, a “SIP dialog” or “dialog” refers to a peer-to-peer SIP relationship between two UAs that persists for some time. Generally, a dialog may include a collection of SIP transactions. A dialog may be established by SIP messages, such as a 2xx response to an INVITE request. As used herein, “calls” and “sessions” may be used interchangeably. A SIP call or session may include multiple dialogs. For example, a session may include multiple user agents communicating with one user agent client. Such an example may result from forking which allows a single request message to be sent to and trigger response messages from multiple user agents. UAs typically attempt to establish a SIP dialog for facilitating sequencing and routing of messages between each other. UAs managed state information for each established dialog, including information to uniquely identify a dialog.

Conventionally, a SIP dialog is identified at each UA by computing a dialog ID for each received message based on a combination of parameters, which include a Call-ID value, a local tag, and a remote tag. These parameters or values (but not the dialog ID, because it has local significance only) are generally included in every message sent after a dialog is established. While a Call-ID value may be the same for each UA in a dialog, the dialog ID is not the same for each UA because the tags used in the dialog ID are defined and interpreted relative to each UA. Specifically, the local tag value at a first UA (e.g., a UAC) is identical to the remote tag value at the peer UA (e.g., a UAS) and the local tag value at the peer UA (e.g., a UAS) is identical to the remote tag value at the first UA (e.g., a UAC). As such, the rules for constructing the dialog ID of a message depend on the SIP element receiving the message.

As described, conventional methods of SIP dialog identification present various shortcomings. One particular shortcoming is that the SIP protocol, as currently defined, does not specify a computed dialog ID parameter that is embedded within messages associated with a SIP dialog and used to uniquely identify these SIP messages as being associated with the same SIP dialog by both UAs. Instead, as stated above each UA must compute, for each received SIP message, a dialog ID using multiple SIP message parameter values. Consequently, the currently specified SIP mechanisms for identifying the dialog with which a SIP message is associated are computationally expensive and time consuming for SIP UAs, because dialog ID computation is repeated by each UA for each message.

Accordingly, in light of these difficulties, a need exists for improved methods, systems, and computer readable media for SIP dialog identification.

### SUMMARY

Methods, systems, and computer readable media for session initiation protocol (SIP) dialog identification are disclosed. According to one method, a first SIP message associated with a SIP dialog is received. A dialog ID that is associated with the SIP dialog is computed using fields of the first SIP message and stored by a first SIP user agent (e.g., UAC, UAS). A second SIP message associated with the SIP dialog is generated. The computed dialog ID is included in the second message. In one implementation, a second SIP user agent receives the second message and uses the embedded dialog ID value to identify the SIP dialog with which the second message is associated.

A system for session initiation protocol (SIP) dialog identification is also disclosed. The system includes a receiving module for receiving a first SIP message associated with a SIP dialog. The system further includes a computing module for computing, using fields of the first SIP message, a dialog ID for identifying the SIP dialog, storing the computed dialog ID value, generating a second SIP message associated with the SIP dialog, and including the computed dialog ID in the second message. A SIP user agent (e.g., UAC, UAS) may receive the second message and uses the embedded dialog ID value to identify the SIP dialog with which the second message is associated.

The subject matter described herein for session initiation protocol (SIP) dialog identification may be implemented using a computer readable medium having stored thereon computer executable instructions that, when executed by the processor of a computer, control the computer to perform the steps of the aforementioned method. Exemplary computer readable media suitable for implementing the subject matter described herein include disk memory devices, chip memory devices, programmable logic devices, and application specific integrated circuits. In one implementation, the computer readable medium may include a memory accessible by a processor. The memory may include instructions executable by the processor for implementing any of the methods for SIP dialog identification described herein. In addition, a computer readable medium that implements the subject matter described herein may be located on a single device or computing platform or may be distributed across multiple devices or computing platforms.

### BRIEF DESCRIPTION OF THE DRAWINGS

The subject matter described herein will now be explained with reference to the accompanying drawings of which:

FIG. 1 is a message flow diagram illustrating exemplary messages exchanged for generating and communicating a SIP dialog ID between SIP entities according to an embodiment of the subject matter described herein;

FIG. 2 is a message flow diagram illustrating exemplary messages exchanged for generating and communicating a SIP dialog ID between SIP entities according to an alternate embodiment of the subject matter described herein;

FIG. 3 is a flow diagram illustrating exemplary steps for generating and communicating SIP dialog ID between SIP entities from a dialog ID generator perspective according to an embodiment of the subject matter described herein;

FIG. 4 is a flow diagram illustrating exemplary steps for generating and communicating SIP dialog ID between SIP entities from a dialog ID user perspective according to an embodiment of the subject matter described herein; and

FIG. 5 is a block diagram of a SIP entity that generates, stores, and/or communicates a SIP dialog ID according to an embodiment of the subject matter described herein.

### DETAILED DESCRIPTION

The subject matter described herein includes methods, systems, and computer readable media for SIP dialog identification. As mentioned above, conventional SIP dialog identification involves the extraction and processing of three values or parameters typically found in every SIP message sent during a dialog between UAs. This parameter extraction and processing is performed de novo for each SIP message received by a SIP user agent. The parameters extracted and processed include a call-ID value and two tags, a local tag and a remote tag, where one tag is generated by each UA when establishing the dialog. A tag includes a token that is globally unique and random or pseudo-random for ensuring unique dialog IDs. The ability to fork SIP requests (i.e., the ability to allow multiple dialogs to be established from a single request) creates a need for a two-sided dialog identifier because without a contribution (i.e., a tag) from recipients, the requesting UA could not distinguish the multiple dialogs established from a single request. As such, tags are defined and maintained relative to a UA. For example, a local tag value for a UAC may be a remote tag value for a UAS and, similarly, a local tag value for the UAS may be a remote tag value for the UAC. As stated above, in conventional SIP network architectures, each time a message is received during a SIP dialog, the receiving UA needs to locate within the message and extract the three parameters. The three parameters extracted from the message are used to construct a dialog ID value for identifying a SIP dialog associated with message. This repetitive computation each time a message is received may be time and resource intensive, and, thus, inefficient for providing or communicating SIP dialog identification.

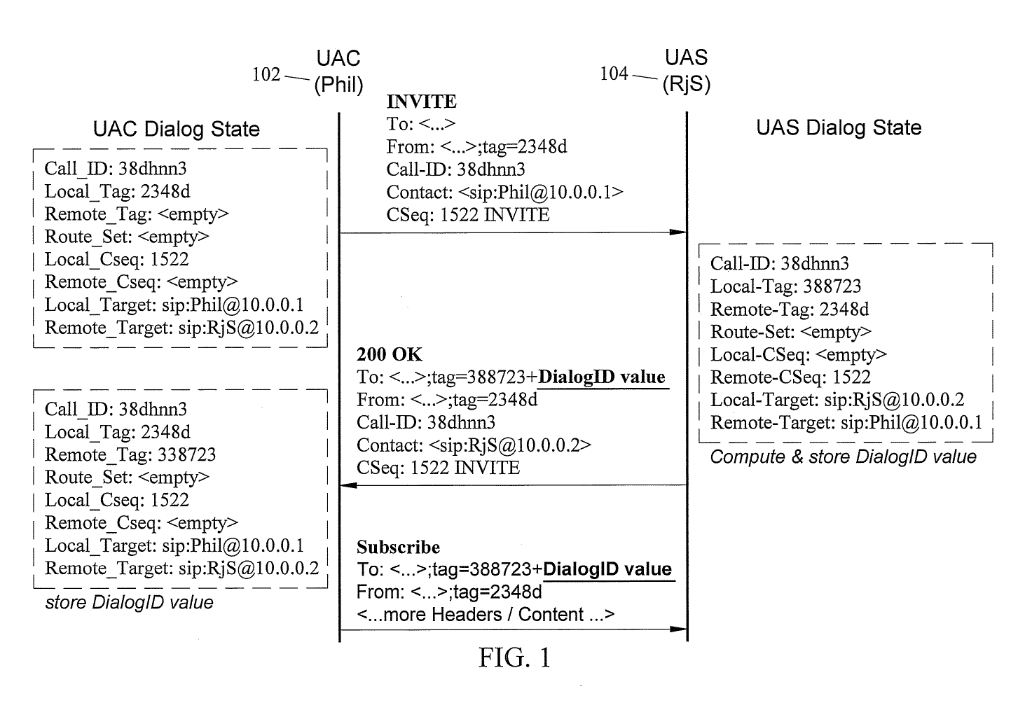

Accordingly, the subject matter described herein provides for SIP dialog identification, where a dialog ID computed by one SIP entity may be shared with and used by other SIP entities associated with a SIP dialog. The subject matter described herein provides a way for including the computed dialog ID in SIP messages associated with a SIP dialog. It is appreciated that one advantage of the subject matter described herein includes allowing a common computed dialog ID to be generated and used throughout a dialog's lifespan without having to compute or recompute the dialog ID every time a message is received at a UA associated with the SIP dialog. As a result, the time and processing resources expended by SIP user agents (or other SIP functional elements) for identifying SIP dialogs is reduced. The subject matter described herein will now be explained in greater detail with reference to FIGS. 1 through 5 below.

FIG. 1 illustrates exemplary messages exchanged between a SIP UAC and a UAS, where the UAC and the UAS exchange and use a computed dialog ID according to an embodiment of the subject matter described herein. In this example, UA 102 wishes to establish a dialog with UA 104. To establish the dialog, UA 102 generates a unique Call ID value and a unique local tag value which are included in the INVITE message and sends the INVITE message to UA 104. UA 104 may receive the INVITE message and generate its own unique Local-tag value. Using the Call ID value, the Local-tag value provided by UA 102 and its own Local-tag value, UA 104 computes a unique dialog ID value. UA 104 associates the computed dialog ID value with the present SIP dialog and stores this dialog ID value. In one embodiment, shown in FIG. 1, UA 104 is adapted to send a non-failure response message, such as a 200 OK message, back to UA 102, thereby establishing a SIP dialog. In this embodiment, UA 104 embeds the computed dialog ID value in the 200 OK message, and thereby explicitly communicates the computed dialog ID value to UA 102. In this example, the dialog ID value is appended to the “To” parameter in the 200 OK message. It will be appreciated that in other embodiments of the subject mater described herein, the dialog ID value can be appended/pre-pended/post-pended or generally included within any header parameter or within the body of the associated SIP message. UA 102 receives the 200 OK message and locates the embedded dialog ID value. UA 102 extracts the embedded dialog ID value, associates the extracted dialog ID value with the present SIP dialog, and stores this dialog ID value. Having identified and stored the dialog ID associated with the SIP dialog, both UA 102 and 104 may include the dialog ID value in some or all subsequent SIP messages associated with the SIP dialog. UA 102 and UA 104 also locate the embedded dialog ID value in each of these subsequent SIP messages and use this dialog ID value to rapidly identify these subsequent SIP messages as being associated with the present SIP dialog.

It should be appreciated that FIG. 1 depicts a network configuration where both the originating user agent and the destination user agent are located on IP-based networks. However, the present subject matter may also be used in other networks that use or provide SIP functionality, including networks that convert SIP messages into other signaling protocols and vice versa. For example, a computed dialog ID may be used in an SS7 network to identify a SIP dialog.

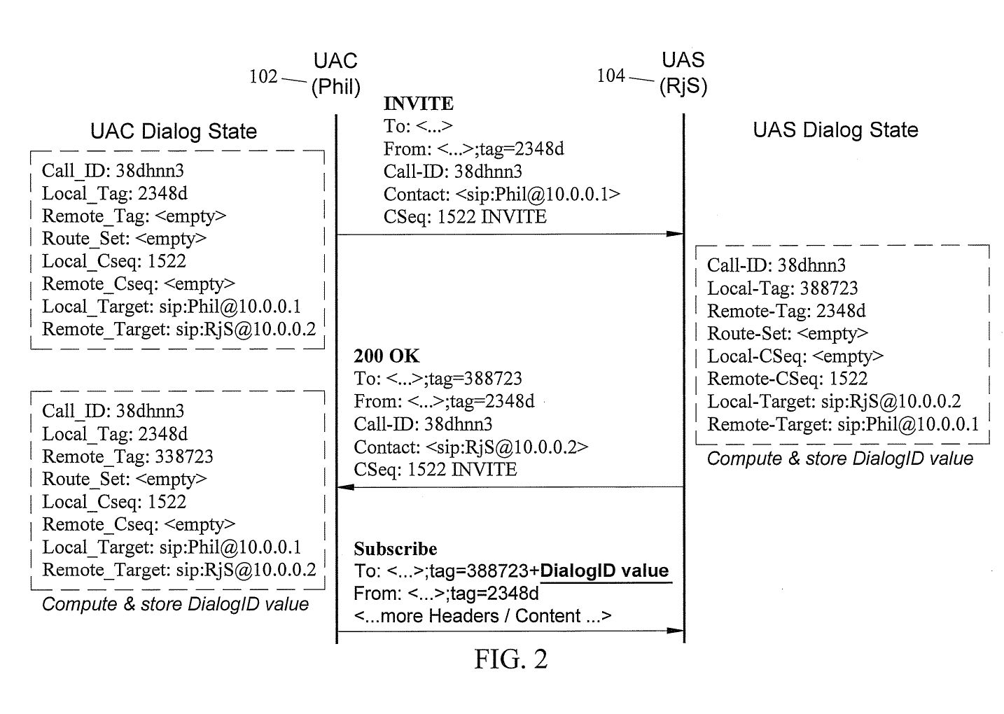

FIG. 2 depicts an alternate embodiment of the present invention. In this example, UA 102 wishes to establish a dialog with UA 104. To establish the dialog, UA 102 generates a unique Call ID value and a unique Local-tag value, which are included in the INVITE message, and sends the INVITE message to UA 104. UA 104 may receive the INVITE message and generate its own unique Local-tag value. Using the Call ID value, the Local-tag value provided by UA 102 and its own Local-tag value, UA 104 computes a dialog ID value. UA 104 associates the computed dialog ID value with the present SIP dialog and stores this dialog ID value. UA 104 may send a non-failure response message, such as a 200 OK message, back to UA 102, thereby establishing a SIP dialog. In this embodiment, UA 104 does not communicate the computed dialog ID value to UA 102, and instead simply provides UA 102 with its own Local-tag value (i.e., the Local-tag value generated by UA 104). UA 102 receives the 200 OK message and extracts the Call ID value, the Local-tag value provided by UA 104 and its own Local-tag value (provided in the 200 OK message as the Remote-tag value). Using these extracted values, UA 102 computes a dialog ID value, which is the same as the dialog ID value previously computed and stored by UA 104. UA 102 associates the computed dialog ID value with the present SIP dialog and stores this dialog ID value. Having computed and stored the dialog ID associated with the SIP dialog, both UA 102 and 104 include the dialog ID value in some or all subsequent SIP messages associated with the SIP dialog. UA 102 and UA 104 may also locate the embedded dialog ID value in these subsequent SIP messages and to use this dialog ID value to rapidly identify these subsequent SIP messages as being associated with the present SIP dialog.

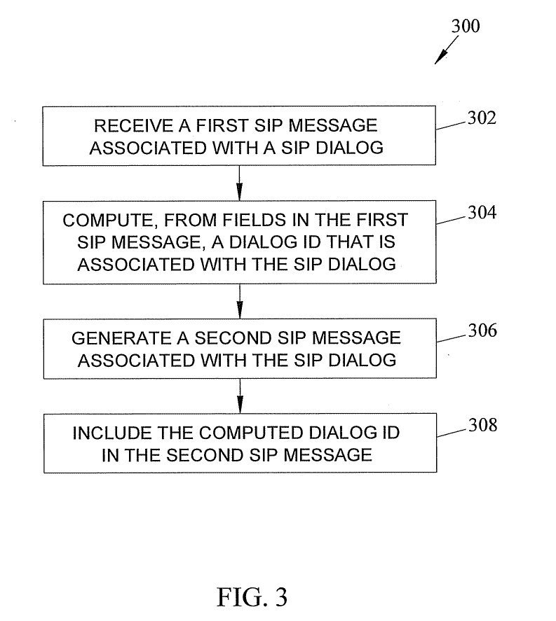

FIG. 3 is a flow chart of a method 300 illustrating exemplary steps for SIP dialog identification according to an embodiment of the subject matter described herein. Referring to FIG. 3, method 300 begins at block 302. In block 302, a first SIP message associated with a SIP dialog is received. For example, an initial INVITE message may be received at UAS 104.

In block 302, a dialog ID that is associated with the SIP dialog is computed using fields of the first SIP message. For example, the INVITE message from the above examples may contain a Call-ID field and a tag parameter in a “From” field. UAS 104 may extract these values. UAS 104 may also generate a second tag value that is not determinable from the first SIP message. Using these three values, UAS 104 may compute the dialog ID based on a cryptographic hash function. For example, the computed dialog ID value may be globally unique and cryptographically random.

In block 304, a second SIP message associated with the SIP dialog is generated. For example, UAS 304 may generate a response SIP message, such as a 200 OK message, for indicating that the SIP INVITE has been received and accepted. In block 306, the computed dialog ID is included in the second message. For example, UAS 104 may include a computed dialog ID in the 200 OK message from the above example. When the 200 OK response message is received, UAC 102 may locate, retrieve, and associate the computed dialog ID with the SIP dialog. Thereafter, the computed dialog ID may be included in subsequent SIP messages generated by UAC 102 or UAS 104 that are associated with the SIP dialog. In one embodiment, a SIP dialog ID value may be placed within a “To” header. In another embodiment, a dialog ID value may be stored in its own dialog ID parameter (e.g., in a Dialog_ID parameter in the header portion of a SIP message). In other embodiments of the present invention, a SIP dialog ID value may be included within any header parameter or the body of the SIP message.

Although the examples described above relate to a UAS compute or generate a dialog ID value, the subject matter described herein is not limited to such an embodiment. The present subject matter allows for other SIP elements to compute or generate a dialog ID value. For example, UAC 102 may compute or generate a dialog ID value. In such an example, UAC 102 may extract a remote tag value from a response message to an initial INVITE message. UAC 102 may compute a dialog ID value and send the computed dialog ID in an ACK message to UAS 104. UAS 104 may use the computed dialog ID value similar to UAC 102 in the description above relating to FIG. 1.

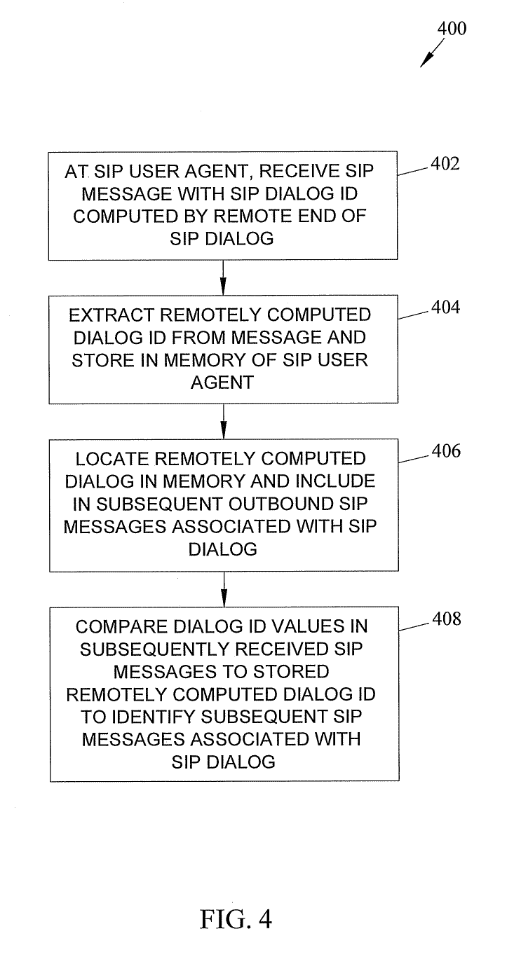

In FIG. 3, the steps are illustrated from the perspective of the entity that first computes a dialog ID value based on parameters and a received SIP message and at least one locally generated parameter. However, the subject matter described herein is not limited to this perspective. For example, in the message illustrated in FIG. 1, from the UAC perspective, there is no computation of a dialog ID value by the UAC. The UAC simply receives the remotely computed dialog ID value from the UAS and stores and uses that dialog ID value to identify subsequent messages associated with the SIP dialog. FIG. 4 is flow chart illustrating exemplary steps that may be implemented by a SIP entity that receives a remotely computed dialog ID to identify SIP messages associated with the SIP dialog. Referring to FIG. 4, a process 400 begins at step 402 where, at a SIP user agent, a SIP message with a SIP dialog ID computed by the remote end of a SIP dialog is received. For example, referring back to FIG. 1, UAC 102 receives a remotely computed dialog ID value in the 200 OK message. In step 404, the remotely computed dialog ID value is extracted from the received message and stored in the memory of the SIP user agent. For example, referring again to FIG. 1, UAC 102 may extract and store the dialog ID value from the 200 OK message. Returning to FIG. 4, in step 406, the user agent may locate the remotely computed dialog ID in its memory and include the remotely computed dialog ID in subsequent outbound SIP messages (i.e., those generated by the user agent) associated with the SIP dialog. Returning to FIG. 1, user agent client 102 may include the remotely computed dialog ID in the subscribe message sent to user agent server 104.

Returning to FIG. 4, in step 408, the user agent compares dialog ID values and subsequently received SIP messages to stored remotely computed dialog ID to identify subsequent SIP messages associated with the SIP dialog. Returning to FIG. 1, if UAC 102 receives a notify message from UAS 104 in response to the subscribe message, and the notify message includes a dialog ID, UAC 102 would compare the dialog ID value in the received notify message to the stored value to determine whether the notify message is associated with the same SIP dialog. Thus, using the steps illustrated in FIG. 4, a SIP entity can use a remotely computed SIP dialog in messages that it originates and to identify messages that it receives as being associated with the SIP dialog. The entity is not required and may not compute a dialog ID value for the dialog.

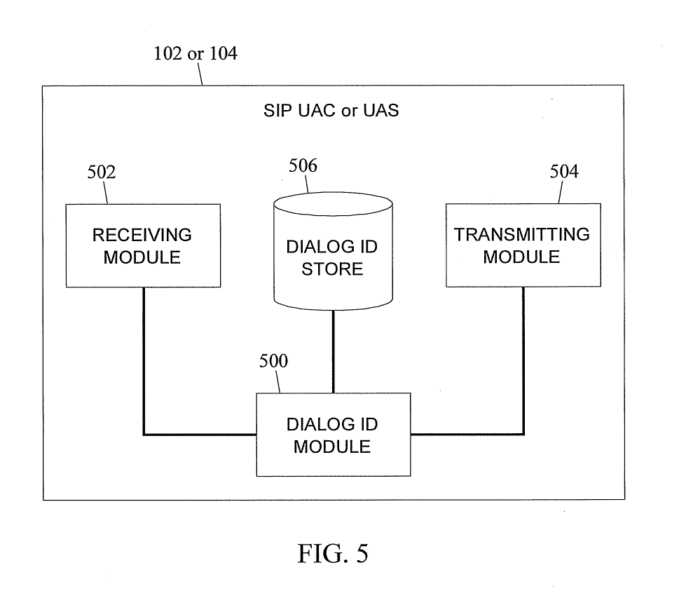

FIG. 5 is a block diagram illustrating an exemplary SIP user agent client or user agent server 102 or 104 according to an embodiment of the subject matter described herein. Referring to FIG. 5, SIP UAC or UAS 102 or 104 includes a dialog ID module 500 that performs the steps described herein for computing, storing, and including a dialog ID in subsequently generated SIP messages or for receiving a remotely computed dialog ID and using that dialog ID for identification of subsequent SIP messages associated with the SIP dialog and the generation of SIP messages associated with the SIP dialog. SIP UAC or UAS 102 or 104 also includes a receiving module 502 that receives SIP messages sent by the remote end of a SIP dialog and a transmitting module 504 for transmitting SIP messages to the remote end of the SIP dialog. SIP UAC or UAS 102 or 104 also includes a dialog ID store 506 that stores dialog IDs that are either computed by SIP UAC or UAS 102 or 104 or that are received and stored by SIP UAC or UAS 102 or 104. Each of the modules illustrated in FIG. 5 may be implemented by a computer programmed to perform the steps described herein for computing or using a SIP dialog ID. In addition, each of the modules and the dialog ID store illustrated in FIG. 5 may be embodied in a computer readable medium, such as those described above.

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A method for assigning and communicating a session initiation protocol (SIP) dialog identification (ID) in a communications network, the method comprising:
at a first SIP entity:
receiving a first SIP message associated with a SIP dialog;
computing, using fields of the first SIP message, a dialog ID for identifying the SIP dialog;
generating a second SIP message associated with the SIP dialog; and
including the computed dialog ID in the second message.

2. The method of claim 1 comprising:
transmitting the second message to at least one second SIP entity with the computed dialog ID positioned in the message in a manner that triggers the second SIP entity to use the dialog ID to identify the SIP dialog.

3. The method of claim 1 wherein SIP user agent elements associated with the SIP dialog utilize the same computed dialog ID to identify the SIP dialog.

4. The method of claim 1 wherein the first SIP message includes a SIP INVITE, SIP REFER, or a SIP SUBSCRIBE message.

5. The method of claim 1 wherein the second message includes a non-failure response to the first SIP message.

6. The method of claim 1 wherein computing, using fields of the first SIP message, a dialog ID for identifying the SIP dialog includes using values from a call ID field and at least one tag parameter of the first SIP message.

7. The method of claim 6 wherein computing, using fields of the first SIP message, a dialog ID for identifying the SIP dialog includes using a second tag value that is not determinable from the first SIP message.

8. The method of claim 7 wherein the computed dialog ID is a function of the call ID value, the second tag value, and the tag value of the first SIP message.

9. The method of claim 1 wherein including the computed dialog ID in the second message includes storing the dialog ID in a header of the second SIP message.

10. The method of claim 1 wherein including the computed dialog ID in the second message includes placing the dialog ID in a To header of the second SIP message.

11. The method of claim 1 wherein the first SIP entity comprises a SIP user agent server (UAS) and the first SIP message is sent by a SIP user agent client (UAC).

12. A method for using a remotely computed session initiation protocol (SIP) dialog ID, the method comprising:
at a SIP user agent, receiving a SIP message with a SIP dialog ID computed by a remote end of a SIP dialog;
extracting the remotely computed dialog ID from the message and storing the remotely computed dialog ID in memory of the SIP user agent;
locating the remotely computed dialog ID in memory of the SIP user agent and including the remotely computed dialog ID in subsequent messages generated by the SIP user agent that are associated with the SIP dialog; and
comparing dialog ID values in subsequently received SIP messages to the stored remotely computed dialog ID to identify subsequent SIP messages associated with the SIP dialog.

13. A system for assigning and communicating a session initiation protocol (SIP) dialog identification (ID) in a communications network, the system comprising:
a first SIP entity including:
a receiving module for receiving a first SIP message associated with a SIP dialog; and
a dialog ID module for computing, using fields of the first SIP message, a dialog ID for identifying the SIP dialog, generating a second SIP message associated with the SIP dialog; and including the computed dialog ID in the second message.

14. The system of claim 13 wherein the dialog ID module is configured for transmitting the second message to at least one second SIP entity with the computed dialog ID positioned in the message in a manner that triggers the second SIP entity to use the dialog ID to identify the SIP dialog.

15. The system of claim 13 wherein SIP user agent elements associated with the SIP dialog utilize the same computed dialog ID to identify the SIP dialog.

16. The system of claim 13 wherein the first SIP message includes a SIP INVITE, SIP REFER, or a SIP SUBSCRIBE message.

17. The system of claim 13 wherein the second message includes a non-failure response to the first SIP message.

18. The system of claim 13 wherein computing, using fields of the first SIP message, a dialog ID for identifying the SIP dialog includes using values from a call ID field and at least one tag parameter of the first SIP message.

19. The system of claim 18 wherein computing, using fields of the first SIP message, a dialog ID for identifying the SIP dialog includes generating a second tag value that is not determinable from the first SIP message.

20. The system of claim 18 wherein the computed dialog ID is a function of the call ID value, the generated second tag value, and the tag value of the first SIP message.

21. The system of claim 13 wherein including the computed dialog ID in the second message includes storing the dialog ID in a header of the second SIP message.

22. The system of claim 13 wherein including the computed dialog ID in the second message includes placing the dialog ID in a To header of the second SIP message.

23. A system for using a remotely computed dialog ID to identify signaling messages associated with a session initiation protocol (SIP) dialog, the system comprising:
a SIP entity including:
a receiving module for receiving a SIP message with a SIP dialog ID computed by a remote end of a SIP dialog; and
a dialog ID module for extracting the remotely computed dialog ID from the message and storing the remotely computed dialog ID in memory of the SIP entity, and for locating the remotely computed dialog ID in memory and including the remotely computed dialog ID in subsequent SIP messages generated by the SIP entity and for comparing dialog ID values in subsequently received SIP messages to the stored remotely computed dialog ID to identify subsequent SIP messages associated with the SIP dialog.

24. A system for assigning and communicating a session initiation protocol (SIP) dialog identification (ID) in a communications network, the system comprising:
a SIP user agent client (UAC) for sending a first SIP message associated with a SIP dialog to a user agent server;
a SIP user agent server (UAS) for receiving the first SIP message, computing, using fields of the first SIP message, a dialog ID for identifying the SIP dialog, generating a second SIP message associated with the SIP dialog, and including the computed dialog ID in the second message.

25. The system of claim 24 wherein the SIP UAS is configured to send the second message including the computed dialog ID to the SIP UAC.

26. The system of claim 24 wherein the SIP UAC is configured to receive the second message and retrieve the computed dialog ID for identifying the SIP dialog.

27. A computer readable medium having stored thereon computer executable instructions that when executed by the processor of a computer control the computer to perform steps comprising:
at a first SIP entity:
receiving a first SIP message associated with a SIP dialog;
computing, using fields of the first SIP message, a dialog ID for identifying the SIP dialog;
generating a second SIP message associated with the SIP dialog; and
including the computed dialog ID in the second message.
